(19) United States
(12) Patent Application Publication
(10) Pub. No.: US 2017/0278035 A1
(43) Pub. Date: Sep. 28, 2017

(54) SYSTEM FOR REAL-TIME RELEASE OF ALLOCATED RESOURCES BASED ON DEVICE STAGE

(71) Applicant: BANK OF AMERICA CORPORATION, Charlotte, NC (US)

(72) Inventors: Manu Jacob Kurian, Dallas, TX (US); Sasidhar Purushothaman, Manikonda (IN)

(21) Appl. No.: 15/082,233

(22) Filed: Mar. 28, 2016

(51) Int. Cl. G06Q 10/06; H04W 4/02; G06Q 40/08; H04W 88/02

(52) U.S. Cl. CPC G06Q 10/06313; H04W 88/02; H04W 4/025; G06Q 40/08

(57) ABSTRACT

Embodiments of the invention are directed to a system, method, or computer program product for real-time release of allocated resources based on construction project stage of completion. The invention identifies and links smart product devices associated with the project. Communication channels provide the invention with smart product data. The data is accumulated and a determination is made as to the stage or completion of a stage of the project. The invention may then communicate a release of resources, such as an inspection set up, material deliver, or the like for initiation of the next stage of the project.

### BACKGROUND

With advancements in machine and product development, more and more machines and products are being interconnected via internet channels. As such, project progress, stage identification, diagnostics, and communications with machinery, products, and the like are becoming more advanced. This allows for assentation of project process and quick diagnostics for maintenance and repair.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method and computer program product real-time release of allocated resources based on project stage of development.

In some embodiments, the invention allows for release of allocated resources based on a step in the project process. For example, some loans, building plans, and the like release resources, such as materials and funds, based on the step the project is in. For example, resources may be released to a builder of a home based on finishing the studs, or the like. This invention automatically identifies a stage in the project process based on smart device signals being correlated from the project site. Subsequently, based on the identification of the stage, the invention triggers the release of resources for the next step in the project process. Furthermore, the stage may be communicated with third parties such as insurance companies, permit providers, and the like in order to update insurance and inspection coverage for the project. Furthermore, the invention may communicate with suppliers to generate an automatic order for materials for subsequent steps based on the completion of one or more steps in the project.

Embodiments of the invention relate to systems, methods, and computer program products for real-time allocated resource release at a project stage, the invention comprising: identifying a project in process and resource allocation requirements for the project in process; identifying one or more smart device systems associated with the project; generating communicable linkage with the one or more smart device systems and receive signals from the one or more smart devices via the communicable linkage; coordinating data associated with signals from the one or more smart devices and identify a stage of the project process; triggering, based on an identification of a completion of the stage of the project process, a communication to a user associated with the project; determining a next stage in the project process; and releasing resources for the next stage of the project based on a determination of the completion of the stage of the project process, wherein the resources are released and provided to the user.

In some embodiments, the invention further comprises identifying the completion of a stage of the project; determining the next stage of the project; and transmitting to a third party a request for product procurement for completion of the next stage. In some embodiments, the third party is a materials provider providing materials for completing the next stage of the project. In some embodiments, the third party is an insurance provider providing insurance for the next stage of the project.

In some embodiments, identifying one or more smart device systems associated with the project further comprises identifying a geographic location of the project using GPS and identifying transmitting signals associated with smart device systems from within the geographic location.

In some embodiments, smart device systems further comprise products or machinery with transmitting signals associated with the product or machinery capable of transmitting a status and use of the product or machinery.

In some embodiments, identifying the stage of the project process further comprises extracting data from the smart device systems and compiling the data to determine machines used and materials used, wherein the machines used and materials used are compared to stage required materials and machinery.

In some embodiments, the project further comprises a construction project, wherein the project is identified based on receiving a project report outlining stages of the product and a time frame for completion of the stages. In some embodiments, resources further comprise funds from a loan for project construction, wherein resources are provided intermittently based on completion of a stage of the project.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a real-time project stage determination resource release system environment, in accordance with one embodiment of the present invention;

FIG. 2 provides a smart device system environment, in accordance with one embodiment of the present invention;

FIG. 3 provides a real-time product stage determination system architecture environment, in accordance with one embodiment of the present invention;

FIG. 4 provides a high level process flow illustrating project stage determination and resource release, in accordance with one embodiment of the present invention;

FIG. 5 provides a process map illustrating communication of information about project stages through smart device communicable linkages, in accordance with one embodiment of the present invention; and

FIG. 6 provides a process map illustrating real-time resource release, in accordance with one embodiment of the present invention; and

FIG. 7 provides a detailed process map illustrating real-time resource release of allocated resources, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “user” as used herein may refer to any entity or individual associated with an ongoing project requiring stages of completion. In some embodiments, identities of an individual may include online handles, usernames, aliases, family names, maiden names, nicknames, or the like. For purposes of this invention, the term “user” and “user” may be used interchangeably. Furthermore, as used herein the term “user device” or “mobile device” may refer to mobile phones, personal computing devices, tablet computers, wearable devices, and/or any portable electronic device capable of receiving and/or storing data therein.

A “project” as used herein includes a process that includes one or more steps and/or has one or more stages of resource or material requirements. A project may include construction, manufacturing, processing, development, or the like. A project may be a building project, a product development project, research project, or the like.

As used herein, a “user interface” generally includes a plurality of interface devices and/or software that allow a customer to input commands and data to direct the processing device to execute instructions. For example, the user interface may include a graphical user interface (GUI) or an interface to input computer-executable instructions that direct the processing device to carry out specific functions. Input and output devices may include a display, mouse, keyboard, button, touchpad, touch screen, microphone, speaker, LED, light, joystick, switch, buzzer, bell, and/or other user input/output device for communicating with one or more users.

A “transaction” or “resource distribution” refers to any communication between a user and the financial institution or other entity monitoring the user's activities to transfer funds for the purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In some embodiments, the invention allows for release of allocated resources based on a step in the project process. For example, some loans, building plans, and the like release resources, such as materials and funds, based on the step the project is in. For example, resources may be released to a builder of a home based on finishing the studs, or the like. This invention automatically identifies a stage in the project process based on smart device signals being correlated from the project site. Subsequently, based on the identification of the stage, the invention triggers the release of resources for the next step in the project process. Furthermore, the stage may be communicated with third parties such as insurance companies, permit providers, and the like in order to update insurance and inspection coverage for the project. Furthermore, the invention may communicate with suppliers to generate an automatic order for materials for subsequent steps based on the completion of one or more steps in the project.

In some embodiments, the smart devices be associated with a network of physical objects such as products, buildings and other items embedded with network connectivity that allow for the objects to collect and exchange data. This exchange allows for objects to be sensed and monitored remotely for maintenance, predictive failures, updates or the like. In this way, creating opportunities for more direct integration of the physical world into computer-based systems, and resulting in improved efficiency, accuracy and economic benefit. When products are augmented with sensors and actuators, the technology allows products to be interoperate within the existing internet infrastructure.

Embodiments of the present invention address the above needs and/or achieve other advantages by providing apparatuses (e.g., a system, computer program product and/or other devices) and methods for real-time resource allocation releasing based on project stage identification from smart devices associated with the project.

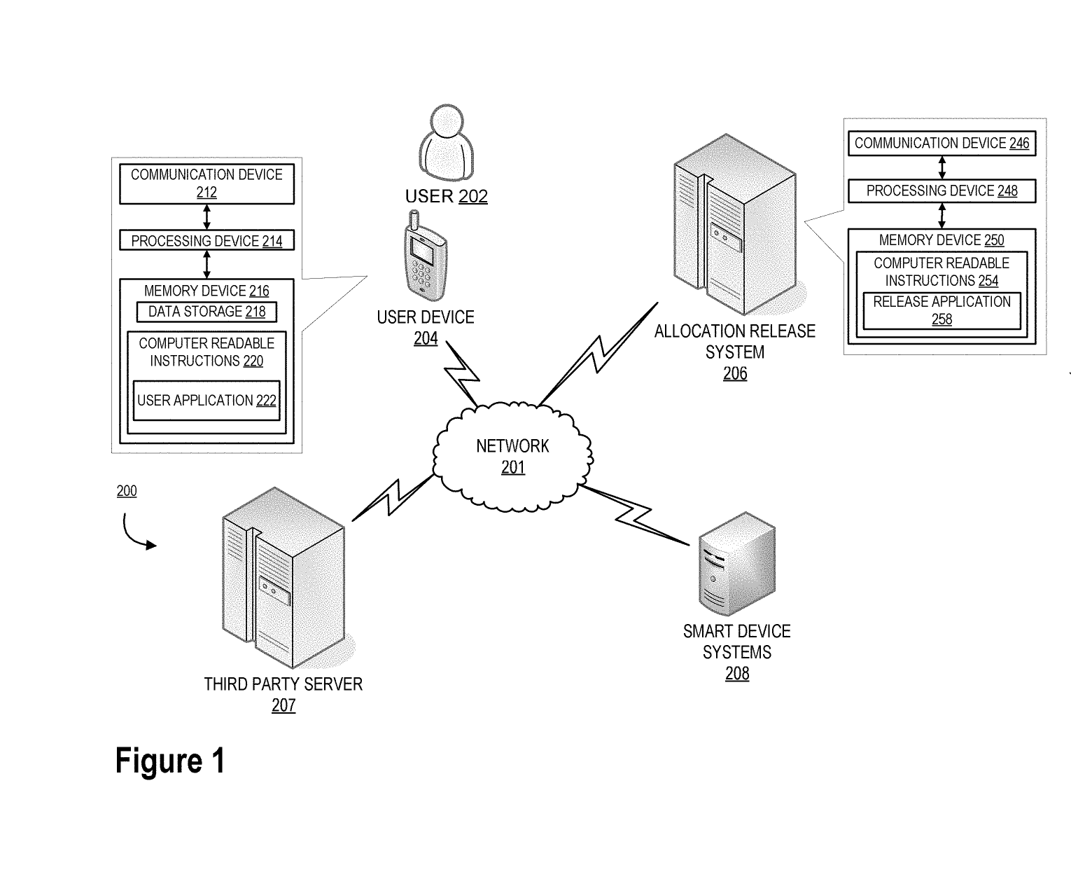

FIG. 1 illustrates a real-time project stage determination resource release system environment 200, in accordance with one embodiment of the present invention. FIG. 1 provides the system environment 200 for which the distributive network system with specialized data feeds associated with the stage determination and resource allocation. FIG. 1 provides a unique system that includes specialized servers and system communicably linked across a distributive network of nodes required to perform the functions of resource allocation based on smart device data compilation.

As illustrated in FIG. 1, the smart device system 208 is operatively coupled, via a network 201 to the user device 204, third party servers 207, and to the allocation release system 206. In this way, the smart device systems 208 can send information to and receive information from the user device 204, third party servers 207, and the allocation release system 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual or entity associated with the project or third party products that are used in or for the project. In other embodiments, the user 202 is an entity. In some embodiments, the user 202 has a user device, such as a mobile phone, tablet, computer, or the like. FIG. 1 also illustrates a user device 204. The user device 204 may be, for example, a desktop personal computer, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the allocation release system 206, the smart device systems 208, and the distributor sever 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to send and receive communications with the allocation release system 206.

As further illustrated in FIG. 1, the allocation release system 206 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the smart device systems 208, the third party server 207, and the user device 204. As such, the communication device 246 generally comprises a modem, server, or other device for communicating with other devices on the network 201.

As further illustrated in FIG. 1, the allocation release system 206 comprises computer-readable instructions 254 stored in the memory device 250, which in one embodiment includes the computer-readable instructions 254 of a release application 258. In some embodiments, the memory device 250 includes data storage 252 for storing data related to the system environment, but not limited to data created and/or used by the release application 258.

In one embodiment of the allocation release system 206 the memory device 250 stores a release application 258. In one embodiment of the invention, the release application 258 may associate with applications having computer-executable program code that generate and code a tag for implementation onto a product. Furthermore, the allocation release system 206, using the processing device 248 codes certain communication functions described herein. In one embodiment, the computer-executable program code of an application associated with the release application 258 may also instruct the processing device 248 to perform certain logic, data processing, and data storing functions of the application.

The processing device 248 is configured to use the communication device 246 to communicate with and ascertain data from one or more smart device systems 208. In the embodiment illustrated in FIG. 1 and described throughout much of this specification, the release application 258 may be coded for smart device system 208 communication for allocation release triggering for a project. As such, the release application 258 may receive communications from the smart device systems 208, decrypt and standardize the received communications such that the communications are compatible with the system, and analyze the communications received to determine a stage of the process of the project.

As illustrated in FIG. 1, the third party server 207 is connected to the smart device systems 208, user device 204, and allocation release system 206. The third party server 207 has the same or similar components as described above with respect to the user device 204 and the allocation release system 206. While only one third party server 207 is illustrated in FIG. 1, it is understood that multiple third party servers 207 may make up the system environment 200. The third party server 207 may be associated with one or more financial institutions, insurance corporations, inspection providers, permit providers, material providers, resource allocators and the like. As such, the allocation release system 206 may communicate with the third party to notify the third party of a real-time update of the project for resource release.

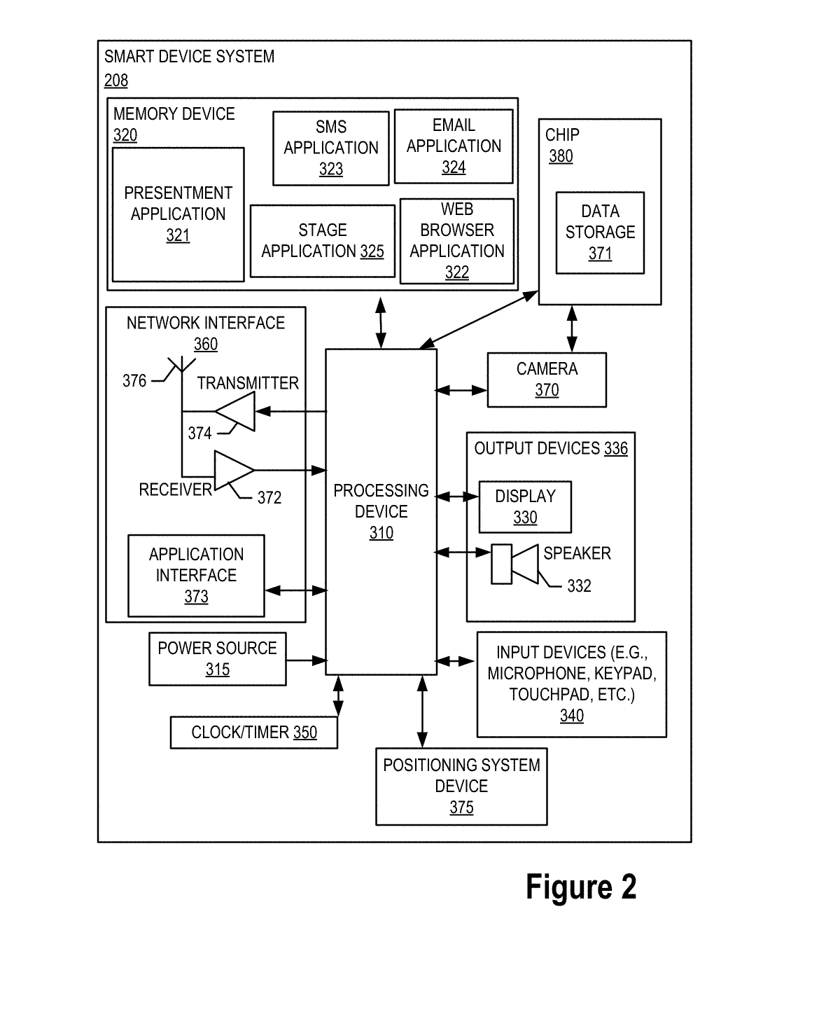

As illustrated in FIG. 1, the smart device systems 208 is connected to the third party server 207, user device 204, and allocation release system 206. The smart device systems 208 is further detailed below with respect to FIG. 2. The smart device systems 208 has the same or similar components as described above with respect to the user device 204 and the allocation release system 206. While only one smart device system 208 is illustrated in FIG. 1, it is understood that multiple smart device systems 208 may make up the system environment 200. It is understood that the servers, systems, and devices described herein illustrate one embodiment of the invention. It is further understood that one or more of the servers, systems, and devices can be combined in other embodiments and still function in the same or similar way as the embodiments described herein.

FIG. 2 illustrates a smart device system environment. A “smart device” or “smart device system” as used herein means a device, apparatus and/or system that is capable of communicating with and transmitting information or data to and/or receiving information or data from other devices, systems or apparatuses including over network 201. The smart device system 208 may be for example, but not limited to, a machine such as an automobile, tractor trailer, airplane, manufacturing device, warehouse devices, material handling system, conveyor system, robotics or the like; appliances such as refrigerators, washer/dryers, dish washers, or the like; home entertainment devices or systems such as set top boxes, gaming systems, internet televisions, or the like; home or building systems such as home security systems, utility systems such as electrical, water, plumbing systems and apparatuses such as electric meters, water meters, hot water heaters, gas meters or the like; and personal devices such as wearable devices such as internet capable fitness devices, watches, glasses or the like. The list of smart devices provided herein is not exhaustive such that the smart device system 208 may be any device that includes a communication interface or module, software and/or hardware that allow the device to communicate data and/or information related to the device with other devices and/or systems over network 201.

The smart device systems 208 may generally include a processing device 310 communicably coupled to devices as a memory device 320, output devices 336, input devices 340, a network interface 360, a power source 315, a clock or other timer 350, a camera 370, a positioning system device 375, one or more chips 380, and the like.

The processing device 310 is operatively coupled to the network communication interface 360 and the memory device 320. The smart device may also have a control system for controlling the physical operation of the device. The control system may comprise one or more sensors for detecting operating conditions of the various mechanical and electrical systems that comprise the smart device or of the environment in which the smart device is used. The sensors may communicate with the processing device 310 to provide feedback to the operating systems of the device. The control system may also comprise metering devices for measuring performance characteristics of the smart device. The control system may also comprise controllers such as programmable logic controllers (PLC), proportional integral derivative controllers (PID) or other machine controllers. The smart device may also comprise various electrical, mechanical, hydraulic or other systems that perform various functions of the smart device. These systems may comprise, for example, electrical circuits, motors, compressors, or any system that enables functioning of the smart device

The processing device 310 may include functionality to operate one or more software programs or applications, which may be stored in the memory device 320. For example, the processing device 310 may be capable of operating a connectivity program, such as a web browser application 322. The web browser application 322 may allow for communication with the allocation release system 206 for providing data about the product for identification of the stage of a project. In this way, the smart device systems 208 may transmit and receive web content, such as, for example, product valuation, location-based content, and/or other web page content, according to a Wireless Application Protocol (WAP), Hypertext Transfer Protocol (HTTP), and/or the like.

The processing device 310 may also be capable of operating applications, such as a stage application 325 and/or a presentment application 321. The stage application 325 and/or presentment application 321 may be downloaded from a server and stored in the memory device 320 of the smart device systems 208. Alternatively, the stage application 325 and/or presentment application 321 may be pre-installed and stored in a memory in the chip 380.

In such an embodiment, the smart device systems 208 may previously store the stage application 325 and/or presentment application 321 prior to affixing the smart device systems 208 to the product. In this way the stage application 325 and/or presentment application 321 may remain and be stored on the smart device systems 208.

The stage application 325 provides the smart device systems 208 with a determination module for the data that the smart device system 208 should communicate to the allocation release system 206. This data is any data that the allocation release system 206 may use to gather information about the stage of the project. For example, this may be an amount of gas left in a vehicle, the number of hours a machine has been running, an amount of materials left on a project, or the like.

The presentment application 321 provides the smart device systems 208 with communication abilities to present the data to the allocation release system 206. In this way, the presentment application 321 may provide information about the product, use of a product, and the like that may provide the allocation release system 206 with an indication as to the stage of the project. The presentment application 321 may communicate with the other devices on the network 201 to provide real-time status of the smart device.

In some embodiments, the smart device systems 208 access one or more databases or datastores (not shown) to search for and/or retrieve information related to the device. In some embodiments, the smart device systems 208 access both a memory and/or datastore local to the smart device systems 208 as well as a datastore remote from the smart device systems 208.

The chip 380 may include the necessary circuitry to provide data gathering and presentation functionality to the smart device systems 208. Generally, the chip 380 will include data storage 371 which may include data associated with the products that the smart device systems 208. The tag chip 380 and/or data storage 371 may be an integrated circuit, a microprocessor, a system-on-a-chip, a microcontroller, or the like. In this way, the chip 308 will included data storage 371 which may include data associated with the presentment application 321.

Of note, while FIG. 2 illustrates the chip 380 as a separate and distinct element within the smart device systems 208, it will be apparent to those skilled in the art that the chip 380 functionality may be incorporated within other elements in the smart device systems 208. For instance, the functionality of the chip 380 may be incorporated within the memory device 320 and/or the processing device 310. In a particular embodiment, the functionality of the chip 380 is incorporated in an element within the smart device systems 208 that provide use information, product activity, product depletion, and the like to the smart device systems 208. Still further, the chip 380 functionality may be included in a removable storage device such as an SD card or the like.

The processing device 310 may be configured to use the network interface 360 to communicate with one or more other devices on a network 201. In this regard, the network interface 360 may include an antenna 376 operatively coupled to a transmitter 374 and a receiver 372 (together a “transceiver”). The processing device 310 may be configured to provide signals to and receive signals from the transmitter 374 and receiver 372, respectively. The signals may include signaling information in accordance with the air interface standard of the applicable cellular system of the wireless telephone network that may be part of the network 201. In this regard, the smart device systems 208 may be configured to operate with one or more air interface standards, communication protocols, modulation types, and access types. By way of illustration, the smart device systems 208 may be configured to operate in accordance with any of a number of first, second, third, and/or fourth-generation communication protocols and/or the like. For example, the smart device systems 208 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The smart device systems 208 may also be configured to operate in accordance with non-cellular communication mechanisms, such as via a wireless local area network (WLAN) or other communication/data networks.

The network interface 360 may also include an application interface 373 in order to allow a user 202 to execute some or all of the above-described processes with respect to the presentment application 321 and/or the chip 380. The application interface 373 may have access to the hardware, e.g., the transceiver, and software previously described with respect to the network interface 360. Furthermore, the application interface 373 may have the ability to connect to and communicate with an external data storage on a separate system within the network 201.

The smart device systems 208 may have an interface that includes user output devices 336 and/or input devices 340. The output devices 336 may include a display 330 (e.g., a liquid crystal display (LCD) or the like) and a speaker 332 or other audio device, which are operatively coupled to the processing device 310. The input devices 340, which may allow the smart device systems 208 to receive data from a user 202, may include any of a number of devices allowing the smart device systems 208 to receive data from a user 202, such as a keypad, keyboard, touch-screen, touchpad, microphone, mouse, joystick, other pointer device, button, soft key, and/or other input device(s).

The smart device systems 208 may further include a power source 315. Generally, the power source 315 is a device that supplies electrical energy to an electrical load. In some embodiment, power source 315 may convert a form of energy such as solar energy, chemical energy, mechanical energy, or the like to electrical energy. Generally, the power source 315 in a smart device systems 208 may be a battery, such as a lithium battery, a nickel-metal hydride battery, or the like, that is used for powering various circuits, e.g., the transceiver circuit, and other devices that are used to operate the mobile device 204. Alternatively, the power source 315 may be a power adapter that can connect a power supply from a power outlet to the smart device systems 208. In such embodiments, a power adapter may be classified as a power source “in” the smart device systems 208.

The smart device systems 208 may also include a memory device 320 operatively coupled to the processing device 310. As used herein, memory may include any computer readable medium configured to store data, code, or other information. The memory device 320 may include volatile memory, such as volatile Random Access Memory (RAM) including a cache area for the temporary storage of data. The memory device 320 may also include non-volatile memory, which can be embedded and/or may be removable. The non-volatile memory may additionally or alternatively include an electrically erasable programmable read-only memory (EEPROM), flash memory or the like.

The memory device 320 may store any of a number of applications or programs which comprise computer-executable instructions/code executed by the processing device 310 to implement the functions of the smart device systems 208 described herein. For example, the memory device 320 may include such applications as a presentment application 321, stage application 325, a web browser application 322, an SMS application 323, an email application 324, or the like.

In some embodiments, the smart device systems 208 may identify the activity or use of the product. The smart device systems 208 may do this via the positioning system device 375, camera 370, and the like. As such, the smart device systems 208 may identify when the product is being used, how often it is being used, and the like. Furthermore, the smart device systems 208 may identify when maintenance may be required based on an identification of the product and regular maintenance required for that product to be maintained.

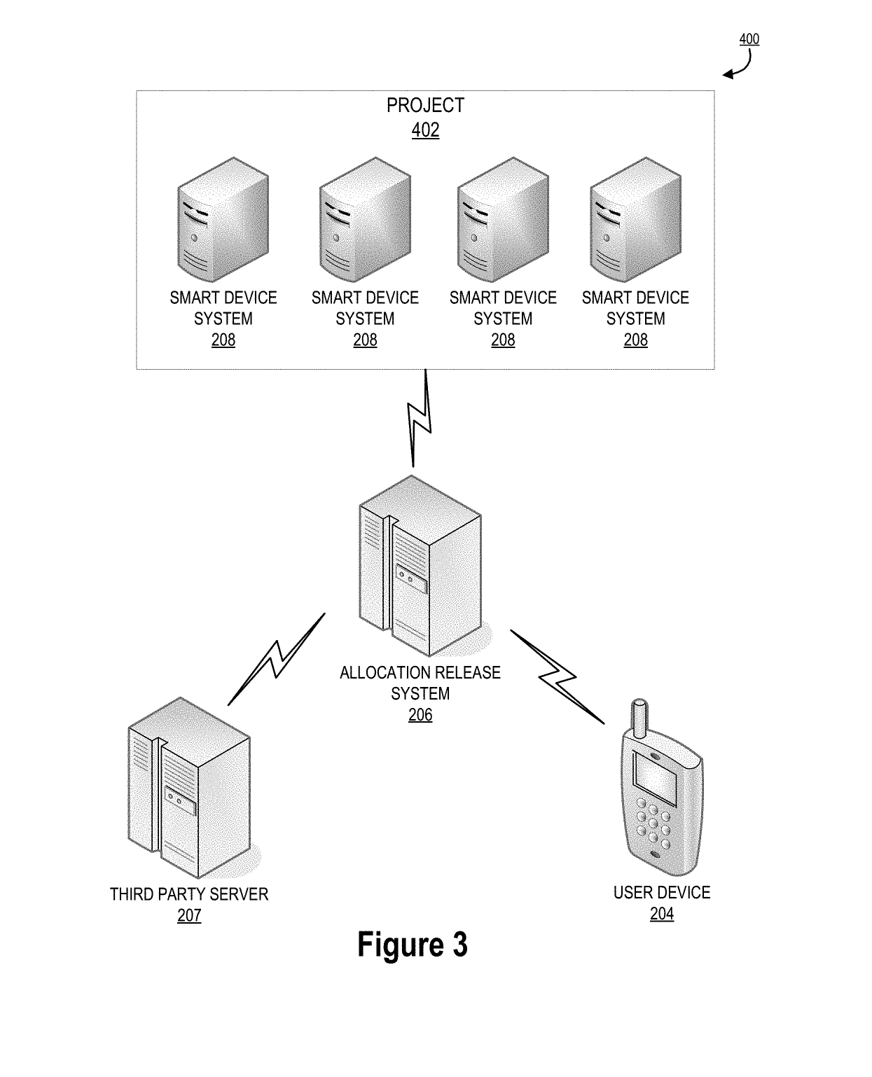

FIG. 3 illustrates a real-time product stage determination system architecture environment 400, in accordance with one embodiment of the present invention. As illustrated, one or more smart device systems 208 may be at or around the project 402 location. This may include equipment, machinery, electronic devices, tools, furniture, buildings, clothing, materials, or the like equipped with technology capably of communicating across one or more devices via an interconnection. The smart devices 208 may be identified as being in proximity, within 100 feet, 500 feet, or the like to the project 402 cite. The system may identify these smart devices 208 based on global positioning, signal recognition, code identification, or the like.

As discussed in further detail above with respect to FIG. 2, a smart device 208 generally includes, but is not limited to, a network communication interface, a processing device, and a memory device such as described herein. The processing device is operatively coupled to the network communication interface and the memory device. The smart device 208 may also have a control system for controlling the physical operation of the device. The control system may comprise one or more sensors for detecting operating conditions of the various mechanical and electrical systems that comprise the smart device 208 or of the environment in which the smart device is used. The sensors may communicate with the processing device to provide feedback to the operating systems of the device. The control system may also comprise metering devices for measuring performance characteristics of the smart device 208. The control system may also comprise controllers such as programmable logic controllers (PLC), proportional integral derivative controllers (PID) or other machine controllers. The smart device 208 may also comprise various electrical, mechanical, hydraulic or other systems that perform various functions of the smart device 208. These systems may comprise, for example, electrical circuits, motors, compressors, or any system that enables functioning of the smart device. The smart device 208 may also include a resource distribution communication interface device that allows the smart device 208 to be connected to and to communicate with devices on the network and including the allocation release system 206. The communication interface device may comprise a wireless local area network (WLAN) such as WiFi based on the Institute of Electrical and Electronics Engineers' (IEEE) 802.11 standards, Bluetooth short-wavelength UHF radio waves in the ISM band from 2.4 to 2.485 GHz or other wireless access technology. Alternatively or in addition to the wireless interface the smart device 208 may also include a communication interface device that may be connected by a hardwire connection to the resource distribution device. The interface device may comprise a connector such as a USB, SATA, PATA, SAS or other data connector for transmitting data to and from the smart device 208 to the allocation release system 206. In some embodiments the smart device 208 may comprise a port or plug that is compatible with a mating port or plug on allocation release system 206.

As such, the smart device systems 208 associated with the project 402 may communicate information about the status of the device which may aid the allocation release system 206 in determining the stage of the project process. This information communicated may include use of products, machine run time, materials available, and/or the like. This information provides the allocation release system 206 with the ability to calculate the stage of each of the project and if/when there is stage completion.

The allocation release system 206 may gather the information and data from the various one or more smart device systems 208 in order to trigger identification of start and stop times of predetermined steps of a project's process. Once the allocation release system 206 receives the data it is processed and translated by the allocation release system 206 to determine the step completion time in real-time.

The allocation release system 206, once the step completion is identified, may communicate the necessary information to third parties and the user based on need for the project to move forward. In some embodiments, the allocation release system 206 may communicate to third party servers 207, such as material providers, inspection providers, resource managers for release of resources for continued project development, insurance companies for added or additional insurance requirements based on the completion of the step or the like. Furthermore, the allocation release system 206 may communicate the step completion to the user device 204 for the user to identify and recognize in real-time the completion of a step of the project.

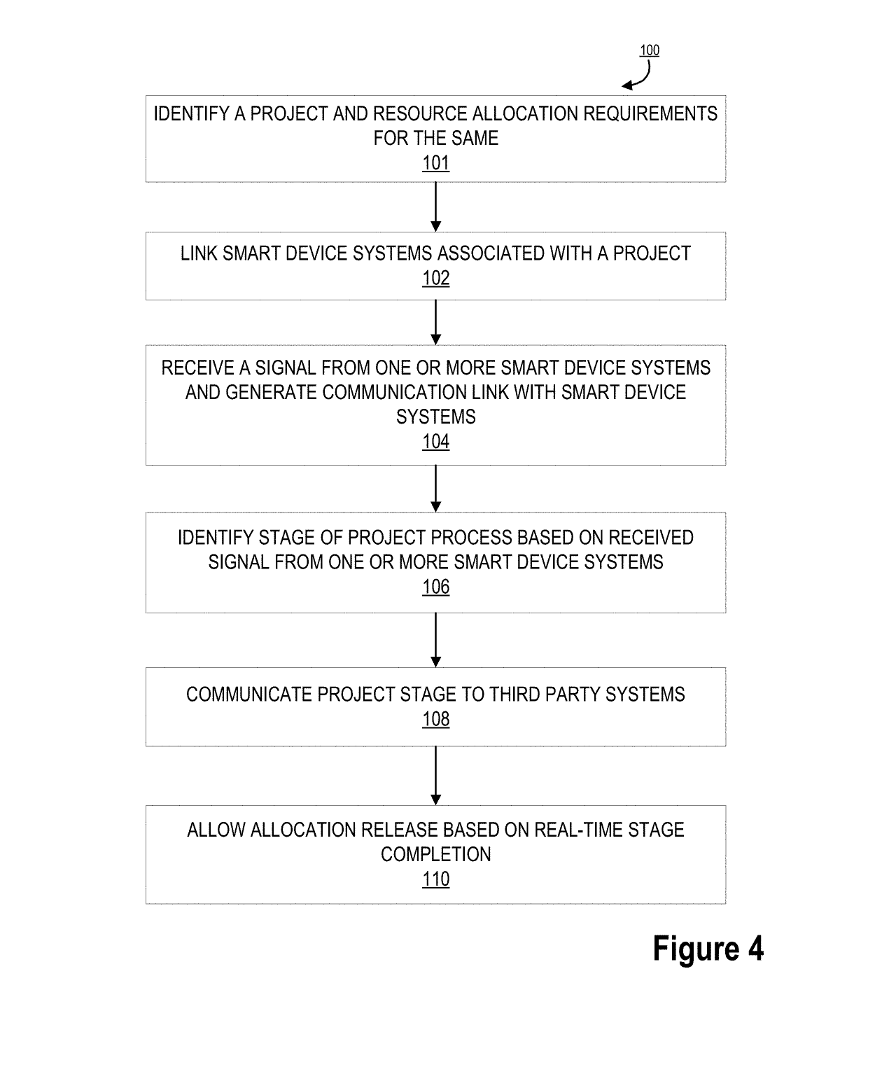

FIG. 4 illustrates a high level process flow for project stage determination and resource release 100, in accordance with one embodiment of the present invention. As illustrated in block 101, the process 100 is initiated by identifying a project and resource allocation requirements for the project. In some embodiments, the system may be presented, via user input, the project.

Once the project has been identified, the system may identify and link the smart device systems associated with the project, as illustrated in block 102. As such, the system may identify the smart device systems in the geographic location of the project. In other embodiments, the system may identify smart device systems associated with the vendors of the project. In yet other embodiments, the system may identify smart device systems that are within a proximate distance to the project. As such, the system may recognize the coding for each of the one or more smart device systems and receive any signal transmitted by the smart device systems associated with the project. In this way, the smart device systems may link the smart device systems that the system identifies as being associated with the project.

Once the smart device systems associated with the project are identified and linked, the process 100 continues by receiving a signal from the one or more smart device systems and generate a communication link with the smart device systems, as illustrated in block 104. As such, once all the smart device systems are link, the system may generate a closed communicable linkage that associates the devices and directs communication from the devices to the system.

Next, as illustrated in block 106, the process 100 continues by identifying the stage of the project process based on the received signal from the one or more smart device systems. In this way, the system may have previously received the stages of the project and the resources that will be provided upon completion of each stage, such as funds, materials, or the like. This map of stages and required resources of those stages may be stored by the system for subsequent use. The system may then, using the data extracted or retrieved from the smart device systems, identify stage or near stage completion. For example, the system may identify that the studs of a building have been completed based on a depreciation of materials or the like. In this way, the system may utilize one or more algorithms, logs, and previously identified stages of a project in correlation with the extracted data from the smart device systems in order to correlate and track the real-time stage completion and/or stage position.

As illustrated in block 108, once the stage is identified, the process 100 continues by communicating the project stage to third party systems and/or the user device. As such, the system may identify the stage and the recently completed stage and communicate the end of that stage to one or more third parties. Finally, as illustrated in block 110, the process 100 finalizes by allowing allocation release based on a real-time stage completion identification.

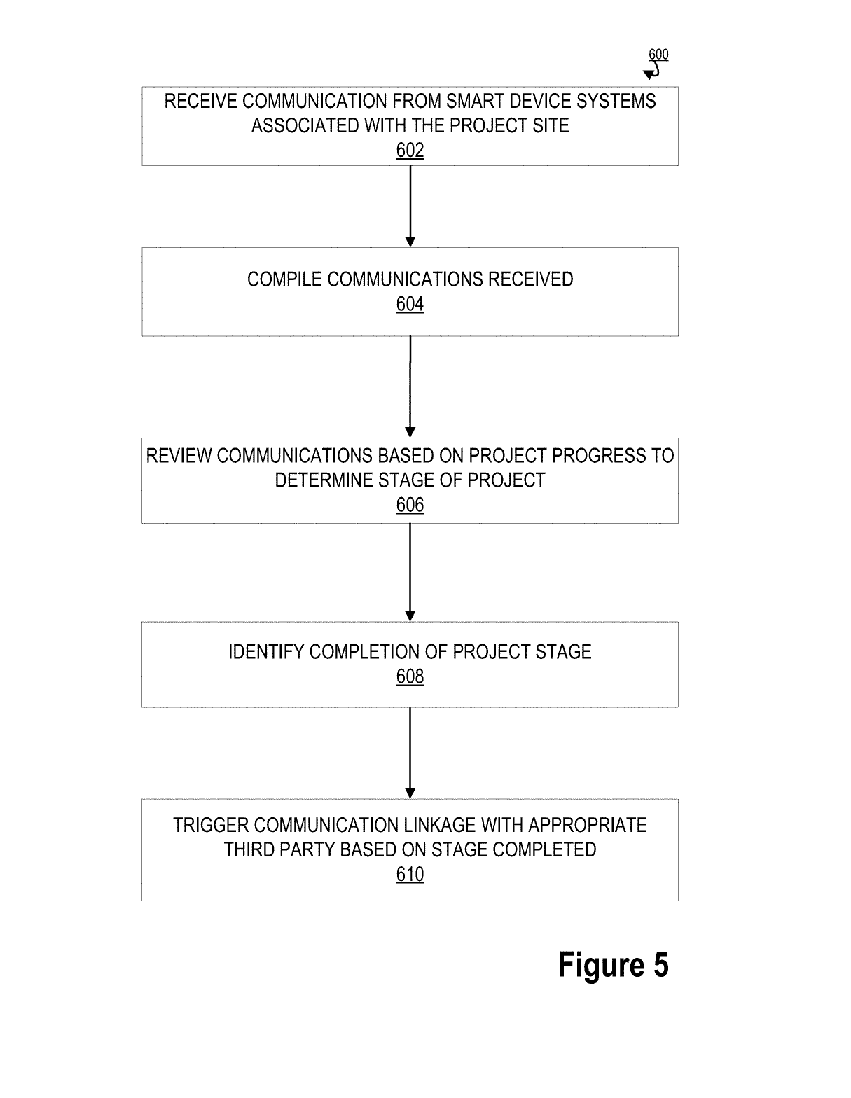

FIG. 5 illustrates a process map for communication of information about project stages through smart device communicable linkages 600, in accordance with one embodiment of the present invention. The process 600, is initiated in block 602 by receiving communication from the smart devices systems associated with the project site. These communications may be data from the smart devices about one or more conditions of materials, machine usage, and the like. Subsequently, the communications received are compiled, as illustrated in block 604. The compiled communications are co-associated with each other and combined in order to determine the stage at which the project is currently at or recently completed.

As illustrated in block 606, the process 600 continues by reviewing the communications based on project progress to determine the stage of the project. In this way, the system continues by reviewing the communications and determining, based on a co-association of the communications, the stage of the project process. Upon reviewing the communications, the system determines the project stage and the real-time start and completion of the project stage.

Next, as illustrated in block 608, the system continues by identifying the completion of the project stage. In this way, the compilation of the collected data from the one or more smart device systems at associated with the project may be utilized in totality to identify with confidence that there has been a completion of a project stage. Furthermore, the data transformation and signaling may be provided to the system in real-time to make assessments of the finalization of one or more stages of the project instantaneously and in real-time as the product stage is being completed.

Once a project stage has been identified as completed, the system is triggered to create a communication linkage with the appropriate third party based on the stage completed, as illustrated in block 610. The communication linkage may be generated between the system and a specific third party based on the stage completed. In this way, the system may prevent communication of the stage completion to unnecessary parties.

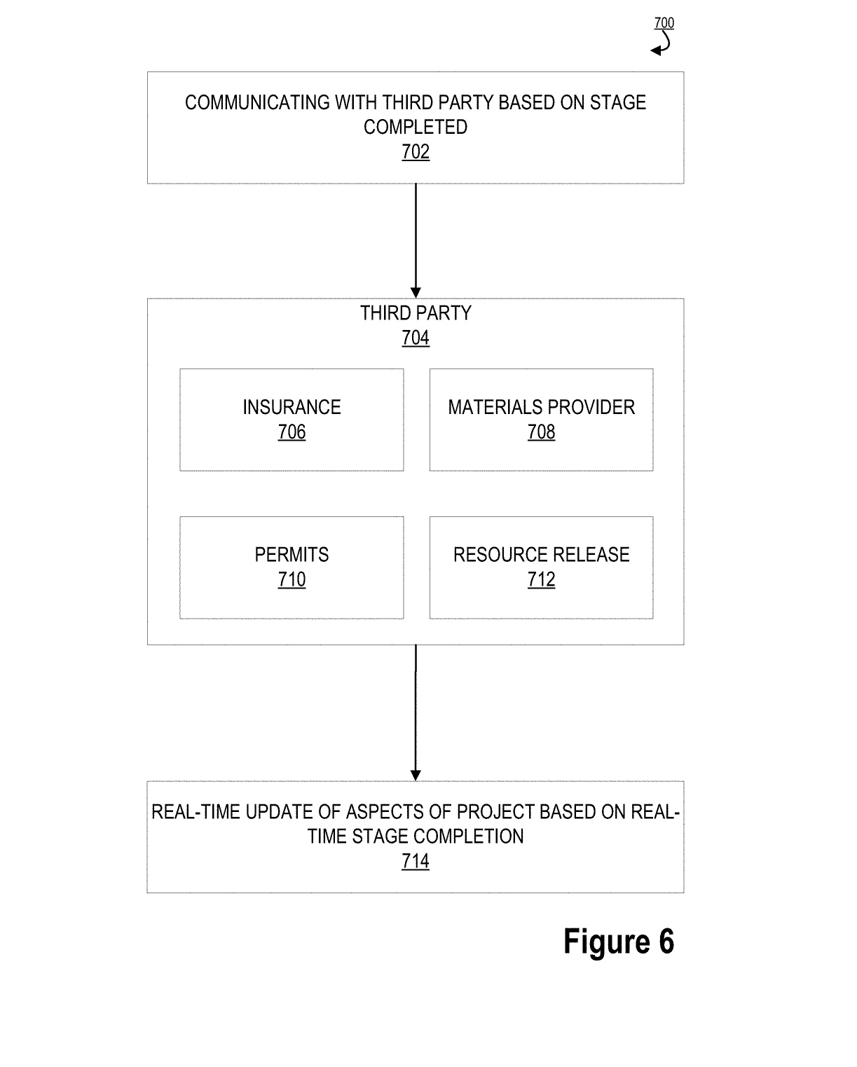

FIG. 6 illustrates a process map for real-time resource release 700, in accordance with one embodiment of the present invention. The process 700 is initiated by communicating with third parties based on the completed stage, as illustrated in block 702. In this way, the system determines the entity type to communicate the stage completion, based on requirements for the next stage. The third parties 704 may include insurance entity 706, a materials provider 708, permit provider 710, and/or resource release 712 by the system.

In some embodiments, the third party 704 may include insurance 706 providing entities. At different stages of construction of a project, there may be one or more changes in insurance coverage or deployment. At the determined stage, the system may communicate with the insurance entity 706 for the particular project to provide the insurance entity 706. As such, the insurance entity 706 may be able to communicate back to the system or the user a real-time update in the insurance for the project such that the project may be able to continue after the determined stage has been completed and be adequately insured.

In some embodiments, the third party 704 may include materials providers 708. At different stages of a project, there may be needs for new material to be delivered for the next step of the project to begin. In this way, the system may recognize the end of materials for one stage and communicate that to a materials provider 708. As such, the materials provider 708 may ship the necessary materials to the project such that there is no delay in the project construction. In some embodiments, the system may communicate to a materials providers 708 prior to the exhaustion of the materials. In other embodiments, the system may communicate to a materials providers 708 at the end of a predetermined stage. For example, at the end of framing a building, the system may identify the end of the framing and order roofing materials or drywall materials.

In some embodiments, the third party 704 may include permit providers 710 or inspection providers. In some instances, once a stage of a project or process is completed, inspections and/or permits may be required in order to be able to move forward to the next stage in the project. The system may identify, from communications with smart device systems at the project that one or more inspections or permits may be required to move to the next stage of the project. For example, once plumbing or electrical is installed in a house, typically inspections will be required prior to moving forward with the project. In this way, the system may recognize the finalized stage requiring permits or inspections and communicate that stage completion to permit providers 710 such that the permit or inspection can take place.

In some embodiments, the third party 704 may include one or more entities that allow for resource release 712. In some loan options or the like, resources such as funds to complete a product and/or move forward with a project may be held and released once a stage of the project is completed. As such, the system may confirm the completion of a stage of the project and transmit a signal for a resource release 712. In some embodiments, the resource release may be from a third party holding the resources. In other embodiments, the system may internally release the resources to the user based on an identification of completion of a stage of the project.

Finally, as illustrated in block 714, the process 700 is completed by providing a real-time update of the aspects of the project based on the real-time stage completion identification.

Furthermore, in some embodiments, the invention may recognize a compatibility of products used during the various stages of the project. As such, one or more products for the next stage may be compatible or incompatible with each other. As such, the system may warn of any incompatibility issues. Furthermore, the system may identify any ordinance or code issues with the interaction of products used at the next stage of the project. Finally, in some embodiments, the system may identify products of recalls based on serial numbers and ensure that these products are not incorporated into the project.

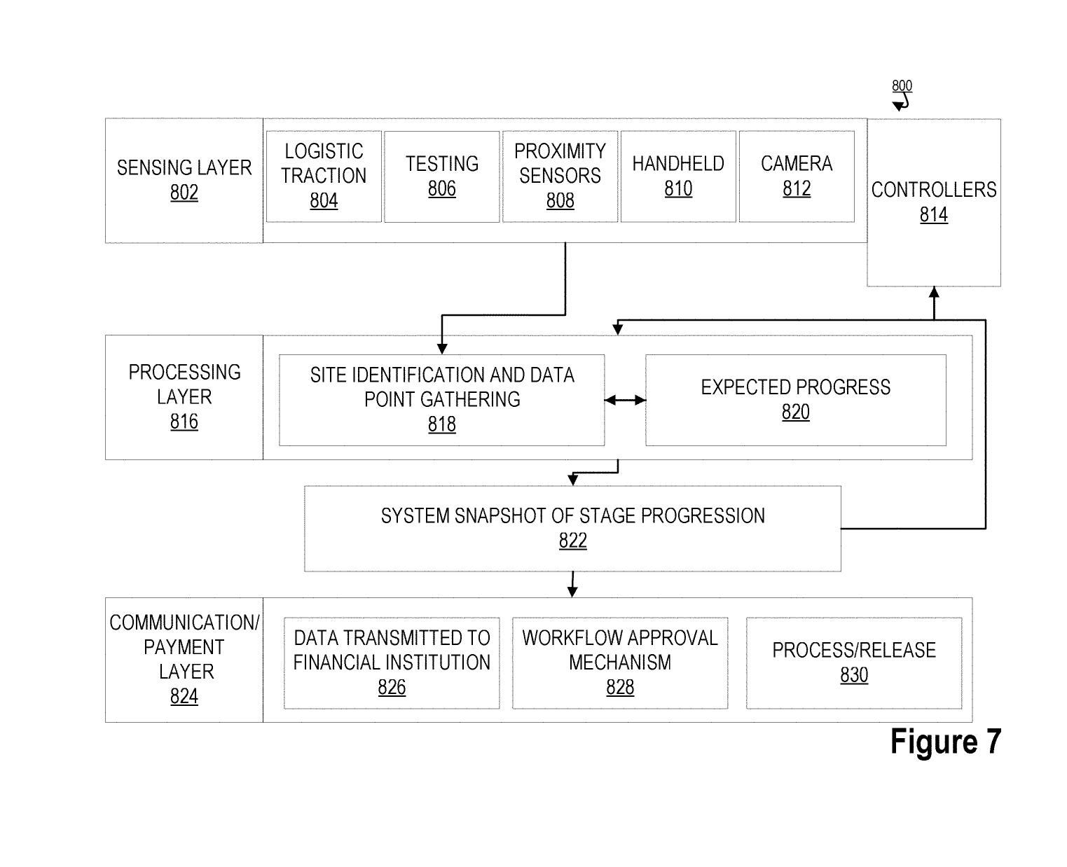

FIG. 7 provides a detailed process map illustrating real-time resource release of allocated resources 800, in accordance with one embodiment of the present invention. The system receives continuous feeds from either proposed smart devices or embedded systems from site constructions and continuously inspects that enables early work flaw detection/evaluation, dimensional measurements, and material characterization. Furthermore, the system provides the ability to remotely control and configure settings including polling frequencies. As illustrated the sensing layer 802 comprises a logistic traction module 804 and a testing module 806. These modules determine logistical and testing considerations and requirements for receiving smart device data for compiling for real-time release of allocated resources. Furthermore, the sensing layer 802 comprises extracting data from proximity sensors 808, handheld devices 810, and cameras 812 associated with or around a location requiring allocated resources. The sensing layer 802 information is compiled and delivered via controllers 814 to the processing layer 816.

As illustrated, the processing layer 816 of the process 800 comprises a site identification and data point gathering portal 818 for identifying the location of the resource allocation stages and for gathering/compiling data associated with the site location. Next, the processing layer 816 has an expected progress 820 system that identifies the expected stage or use of the resources for subsequent release. This is a model format that predicts the stage the process is expected to be in at this time.

Next, as illustrated in block 822 the process 800 continues by creating a system wide snapshot of the stage progression. As such, the system may identify the stage of the project and determine if one or more resources may be released.

As illustrated, the communication/payment layer 824 comprises communicating data in a transmitted form to a financial institution 826, a workflow approval mechanism 828, and a process/release mechanism 830 for releasing resources.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent Application | | |
|---|---|---|---|
| Docket Number | Ser. No. | Title | Filed On |
| 7085US1.014033.2722 | To be assigned | ENHANCING AUTHENTICATION | Concurrently |
| | | AND SOURCE OF PROOF | herewith |
| | | THROUGH A DYNAMICALLY | |
| | | UPDATABLE BIOMETRICS | |
| | | DATABASE | |
| 7086US1.014033.2723 | To be assigned | RESOURCE TAG GENERATION | Concurrently |
| | | AND DEPLOYMENT FOR | herewith |
| | | RESOURCE VALUATION AND | |
| | | DISTRIBUTION | |
| 7090US1.014033.2725 | To be assigned | SECURITY IMPLEMENTATION | Concurrently |
| | | FOR RESOURCE DISTRIBUTION | herewith |
| 7097US1.014033.2726 | To be assigned | SECURITY IMPLEMENTATION | Concurrently |
| | | FOR USER RESOURCE | herewith |
| | | DISTRIBUTION WITH | |
| | | PERIPHERAL DEVICE | |
| 7098US1.014033.2727 | To be assigned | INTELLIGENT RESOURCE | Concurrently |
| | | PROCUREMENT SYSTEM | herewith |
| | | BASED ON PHYSICAL | |
| | | PROXIMITY TO RELATED | |
| | | RESOURCES | |
| 7082US1.014033.2728 | To be assigned | SYSTEM FOR MACHINE- | Concurrently |
| | | INITIATED RESOURCE | herewith |
| | | GENERATION AND | |
| | | CUSTOMIZATION | |
| 7083US1.014033.2729 | To be assigned | SECURITY IMPLEMENTATION | Concurrently |
| | | FOR USER RESOURCE | herewith |
| | | DISTRIBUTION | |
| 7084US1.014033.2730 | To be assigned | SYSTEM FOR ADAPTATION OF | Concurrently |
| | | MULTPLE DIGITAL | herewith |
| | | SIGNATURES IN A | |
| | | DISTRIBUTED NETWORK | |

What is claimed is:

1. A system for real-time allocated resource release at a project stage, the system comprising:
a memory device with computer-readable program code stored thereon;
a communication device;
a processing device operatively coupled to the memory device and the communication device, wherein the processing device is configured to execute the computer-readable program code to:
identify a project in process and resource allocation requirements for the project in process;
identify one or more smart device systems associated with the project;
generate communicable linkage with the one or more smart device systems and receive signals from the one or more smart devices via the communicable linkage;
coordinate data associated with signals from the one or more smart devices and identify a stage of the project process;
trigger, based on an identification of a completion of the stage of the project process, a communication to a user associated with the project;
determine a next stage in the project process; and
release resources for the next stage of the project based on a determination of the completion of the stage of the project process, wherein the resources are released and provided to the user.

2. The system of claim 1, further comprising:
identifying the completion of a stage of the project;
determining the next stage of the project; and
transmitting to a third party a request for product procurement for completion of the next stage.

3. The system of claim 2, wherein the third party is a materials provider providing materials for completing the next stage of the project.

4. The system of claim 2, wherein the third party is an insurance provider providing insurance for the next stage of the project.

5. The system of claim 1, wherein identifying one or more smart device systems associated with the project further comprises identifying a geographic location of the project using GPS and identifying transmitting signals associated with smart device systems from within the geographic location.

6. The system of claim 1, wherein smart device systems further comprise products or machinery with transmitting signals associated with the product or machinery capable of transmitting a status and use of the product or machinery.

7. The system of claim 1, wherein identifying the stage of the project process further comprises extracting data from the smart device systems and compiling the data to determine machines used and materials used, wherein the machines used and materials used are compared to stage required materials and machinery.

8. The system of claim 1, wherein the project further comprises a construction project, wherein the project is identified based on receiving a project report outlining stages of the product and a time frame for completion of the stages.

9. The system of claim 1, wherein resources further comprise funds from a loan for project construction, wherein resources are provided intermittently based on completion of a stage of the project.

10. A computer program product for real-time allocated resource release at a project stage, the computer program product comprising at least one non-transitory computer-readable medium having computer-readable program code portions embodied therein, the computer-readable program code portions comprising:
an executable portion configured for identifying a project in process and resource allocation requirements for the project in process;
an executable portion configured for identifying one or more smart device systems associated with the project;
an executable portion configured for generating communicable linkage with the one or more smart device systems and receive signals from the one or more smart devices via the communicable linkage;
an executable portion configured for coordinating data associated with signals from the one or more smart devices and identify a stage of the project process;
an executable portion configured for triggering, based on an identification of a completion of the stage of the project process, a communication to a user associated with the project;
an executable portion configured for determining a next stage in the project process; and
an executable portion configured for releasing resources for the next stage of the project based on a determination of the completion of the stage of the project process, wherein the resources are released and provided to the user.

11. The computer program product of claim 10, further comprising:
an executable portion configured for identifying the completion of a stage of the project;
an executable portion configured for determining the next stage of the project; and
an executable portion configured for transmitting to a third party a request for product procurement for completion of the next stage, wherein the third party is a materials provider providing materials for completing the next stage of the project or an insurance provider providing insurance for the next stage of the project.

12. The computer program product of claim 10, wherein identifying one or more smart device systems associated with the project further comprises identifying a geographic location of the project using GPS and identifying transmitting signals associated with smart device systems from within the geographic location.

13. The computer program product of claim 10, wherein smart device systems further comprise products or machinery with transmitting signals associated with the product or machinery capable of transmitting a status and use of the product or machinery.

14. The computer program product of claim 10, wherein identifying the stage of the project process further comprises extracting data from the smart device systems and compiling the data to determine machines used and materials used, wherein the machines used and materials used are compared to stage required materials and machinery.

15. The computer program product of claim 10, wherein the project further comprises a construction project, wherein the project is identified based on receiving a project report outlining stages of the product and a time frame for completion of the stages.

16. The computer program product of claim 10, wherein resources further comprise funds from a loan for project construction, wherein resources are provided intermittently based on completion of a stage of the project.

17. A computer-implemented method for real-time allocated resource release at a project stage, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
identifying a project in process and resource allocation requirements for the project in process;
identifying one or more smart device systems associated with the project;
generating communicable linkage with the one or more smart device systems and receive signals from the one or more smart devices via the communicable linkage;
coordinating data associated with signals from the one or more smart devices and identify a stage of the project process;
triggering, based on an identification of a completion of the stage of the project process, a communication to a user associated with the project;
determining a next stage in the project process; and
releasing resources for the next stage of the project based on a determination of the completion of the stage of the project process, wherein the resources are released and provided to the user.

18. The computer-implemented method of claim 17, further comprising:
identifying the completion of a stage of the project;
determining the next stage of the project; and
transmitting to a third party a request for product procurement for completion of the next stage, wherein the third party is a materials provider providing materials for completing the next stage of the project or an insurance provider providing insurance for the next stage of the project.

19. The computer-implemented method of claim 17, wherein identifying one or more smart device systems associated with the project further comprises identifying a geographic location of the project using GPS and identifying transmitting signals associated with smart device systems from within the geographic location.

20. The computer-implemented method of claim 17, wherein identifying the stage of the project process further comprises extracting data from the smart device systems and compiling the data to determine machines used and materials used, wherein the machines used and materials used are compared to stage required materials and machinery.
